(19) United States
(12) Patent Application Publication
(10) Pub. No.: US 2014/0017354 A1
(43) Pub. Date: Jan. 16, 2014

(54) BEER BREWING SYSTEM AND METHOD

(71) Applicants: James Joseph, Hillsborough, NC (US); Brandy Callanan, Cary, NC (US)

(72) Inventors: James Joseph, Hillsborough, NC (US); Brandy Callanan, Cary, NC (US)

(21) Appl. No.: 13/935,684

(22) Filed: Jul. 5, 2013

Related U.S. Application Data
(60) Provisional application No. 61/668,240, filed on Jul. 5, 2012.

(51) Int. Cl. C12C 7/04

(52) U.S. Cl. CPC C12C 7/04
USPC 426/16; 99/278; 99/276

(57) ABSTRACT

The present subject matter relates to systems and methods for automated, whole grain brewing. In one configuration, such a system can include a base, a boil kettle positioned on the base, a first heating element in communication with the boil kettle and configured to selectively heat fluid contained in the boil kettle, and a mash tun positioned on the base, the mash tun configured to receive one or more solid or fluid materials therein. A pumping system positioned at least partially within the base can be connected to the boil kettle and the mash tun, the pumping system being operable to selectively pass fluid into, out of, and among the boil kettle and the mash tun. In addition, a control system can be positioned at least partially within the base and configured to selectively control the first heating element and the pumping system.

### PRIORITY CLAIM

The present application claims the benefit of U.S. Patent Application Ser. No. 61/668,240, filed Jul. 5, 2012, the disclosure of which is incorporated herein by reference in its entirety.

### TECHNICAL FIELD

The subject matter disclosed herein relates generally to systems and methods for brewing beer. More particularly, the subject matter disclosed herein relates to automated, whole grain brewing systems and methods.

### BACKGROUND

Homebrewing is an increasingly popular hobby in which individuals produce homemade beer through fermentation on a small scale for personal consumption, free distribution at social gatherings, amateur brewing competitions, or other non-commercial reasons. The brewing process can generally be broken down into a few basic steps. First, malted barley (or alternative grain adjuncts such as unmalted barley, wheat, oats, corn or rye) is soaked in hot water to release the malt sugars. The malt sugar solution is then boiled, and hops are commonly added to add bitterness and serve as a natural preservative. The solution is then cooled, and yeast is added to begin fermentation. During fermentation, the yeast ferments the sugars, releasing CO2 and ethyl alcohol to create beer. Despite the general simplicity of the brewing process, home brewers can adjust the particular malts, hops, and yeasts used and their proportions, they can subtly vary the duration and temperature at which some brewing steps are performed, and they can add additional ingredients to suit their own tastes to create beverages that are unavailable on the open market.

This customization is especially true in a whole-grain or all-grain brewing process. In contrast to “extract” brewing in which concentrated malt extract is purchased as the source of malt sugars, whole-grain brewing involves the home brewer extracting the malt sugars from raw milled malted grain using hot water in a process called “mashing.” Although whole-grain brewing gives the brewer greater control over the finished beer, the additional steps of mashing the grains can require a greater understanding of the brewing process and the added cost of some specialized equipment, including a vessel known as a mash tun and means of carefully controlling the temperature of the mash to ensure that proper enzymatic activity occurs to produce the desired malt sugars. These additional requirements effectively create barriers to entry for home brewers wishing to take more control over the brewing process. Even for those that do undertake the added time and expense to assemble a proper whole-grain brewing system, most commercially-available equipment and homebrew recipes are scaled to produce five-gallon batches of beer. Even if smaller batches are desired, the equipment cost and space requirements can be substantially fixed, and the brewer would still need to carefully control each aspect of the brewing process to produce the desired flavors.

As a result, it would be desirable for a smaller-scale brewing system to be available that minimizes the cost and space required for whole-grain brewing. In addition, it would be advantageous for such a system to be partially or fully automated such that the brewing process can be simplified, particularly for new brewers.

### SUMMARY

In accordance with this disclosure, systems and methods for automated, whole grain brewing are provided. In one aspect, a system for brewing beer is provided. The system can include a base, a boil kettle positioned on the base, a first heating element in communication with the boil kettle and configured to selectively heat fluid contained in the boil kettle, and a mash tun positioned on the base, the mash tun configured to receive one or more solid or fluid materials therein. A pumping system positioned at least partially within the base can be connected to the boil kettle and the mash tun, the pumping system being operable to selectively pass fluid into, out of, and among the boil kettle and the mash tun. In addition, a control system can be positioned at least partially within the base and configured to selectively control the first heating element and the pumping system.

In another aspect, a system for brewing beer can include a base, a water tank positioned on the base, a boil kettle positioned on the base, a first heating element in communication with the boil kettle and configured to selectively heat fluid contained in the boil kettle, a mash tun positioned on the base, the mash tun configured to receive one or more solid or fluid materials therein, and a fermentation chamber positioned on the base. A pumping system positioned can be at least partially within the base and connected to the water tank, the boil kettle, the mash tun, and the fermentation chamber. The pumping system can have a pump operable to selectively pass fluid into, out of, and among the water tank, the boil kettle, the mash tun, and the fermentation chamber. A wort chiller can further be provided in communication with the pumping system between the boil kettle and the pump for selectively cooling liquid pumped from the boil kettle. A control system can also be positioned at least partially within the base and configured to selectively control the first heating element, the pumping system, and the wort chiller.

In yet another aspect, the present subject matter provides a method for brewing beer. The method can involve adding brewing grains to a mash tun positioned on a base and transferring water to a boil kettle positioned on the base. Using a first heating element in communication with the boil kettle, the water in the boil kettle can be heated to a desired temperature. Using a pumping system positioned at least partially within the base, the water can be pumped from the boil kettle onto the brewing grains in the mash tun to form a wort. Again using the pumping system, the wort can be pumped from the mast tun to the boil kettle, and the first heating element can again be used to heat the wort to form a heated wort. Using a wort chiller in communication with the pumping system, the heated wort can be cooled to form a cooled wort. Yeast can be added to the cooled wort, and using the pumping system, the cooled wort can be transferred from the boil kettle to a fermentation chamber. In this method, the steps of heating the water in the boil kettle, pumping the water from the boil kettle, pumping the wort from the mast tun, heating the wort, cooling the heated wort, and transferring the cooled wort from the boil kettle can all be selectively controlled by a control system positioned at least partially within the base.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1A is a front perspective view of a beer brewing system according to an embodiment of the presently disclosed subject matter;

FIG. 1B is a rear perspective view of a beer brewing system according to an embodiment of the presently disclosed subject matter;

FIG. 2 is a front exploded view of a beer brewing system according to an embodiment of the presently disclosed subject matter;

FIG. 3 is a perspective view of a fluid pumping system for use in a beer brewing system according to an embodiment of the presently disclosed subject matter;

FIG. 4 is a cutaway side view of a boil kettle for use in a beer brewing system according to an embodiment of the presently disclosed subject matter;

FIG. 5 is a cutaway side view of a mash tun for use in a beer brewing system according to an embodiment of the presently disclosed subject matter;

FIG. 6 is a top perspective view of an additions dispenser for use in a beer brewing system according to an embodiment of the presently disclosed subject matter;

FIG. 7 is a side perspective view of a yeast mixer for use in a beer brewing system according to an embodiment of the presently disclosed subject matter; and

FIG. 8 is a combined electrical and plumbing schematic of a beer brewing system according to an embodiment of the presently disclosed subject matter.

### DETAILED DESCRIPTION

The present subject matter provides systems and methods for automated, whole grain brewing. In particular, an automated, small-scale, whole-grain brew system is disclosed herein. Such systems and methods can be of particular interest to home-brewers looking for a low cost alternative to larger home-brew systems. Further, the disclosed systems and methods can enable safe, easy, and clean all-grain home-brewing indoors on a counter top.

One advantage of a smaller system compared to conventional brewing configurations is that less ingredients need to be used per batch allowing for broader experimentation with specialty grains and ingredients at lower cost. Another advantage of a smaller system is that it can be operated in a limited space, opening the art of home brewing to a wider market of individuals who do not wish to dedicate a large amount of space to storing and operating brewing equipment. Furthermore, all of the electrical power for the system can be provided by conventional wall-mounted electrical sockets (e.g., providing 120 VAC), so specialty power supplies need not be provided. In addition, the present systems and methods can incorporate computer controlled operation, thereby allowing greater repeatability and data logging, helping to reduce the chances of ‘bad batch,’ and allowing novice brewers to implement complex recipes with a greater chance of a successful final product. In this way, one can be able to implement nearly any brew recipe starting with the most basic ingredients of grains, water, hops, flavor and aromatic additions, and yeast. All of these features, both individually and when taken together, can allow the present systems and methods to make beer brewing more accessible to a wider market of users.

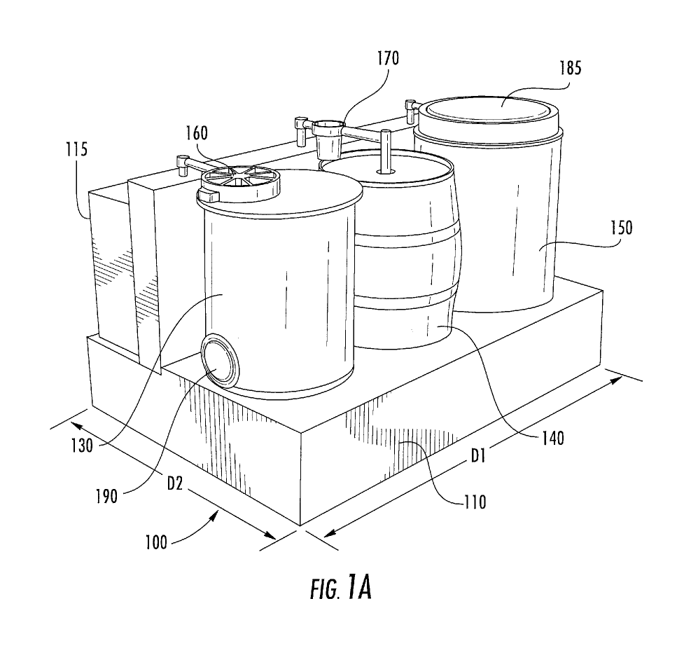

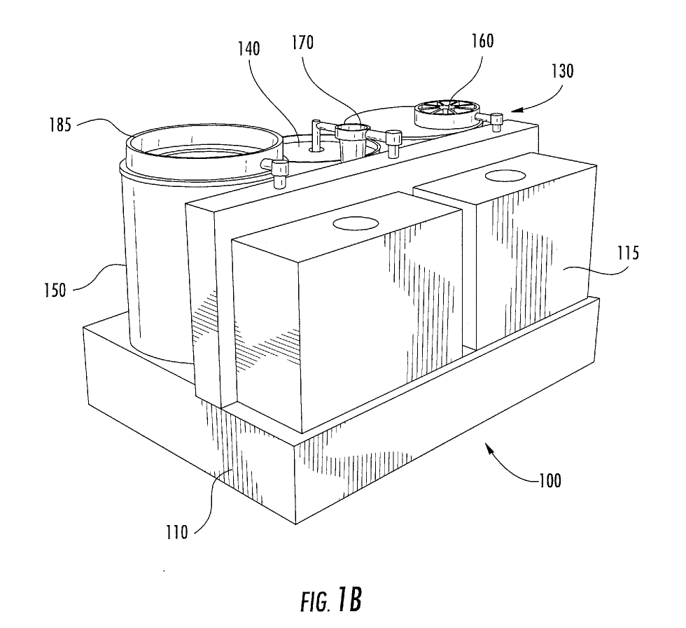

In one aspect shown in FIGS. 1A, 1B, and 2, the present subject matter provides a system for brewing beer, generally designated 100. System 100 can include a system base 110 that defines an area footprint of the system 100. The base 110 can include spaces on which can be positioned one or more of a water tank 115, a boil kettle 130, a fermentation chamber 140, and/or a mash tun 150. In addition, as shown in FIG. 2, a pumping system, generally designated 120, and a control system 111 can be contained at least partially within base 110. In this configuration, many of the components commonly used in a home brewing set-up can be integrated together in a single, comparatively compact system.

In fact, the base footprint can be sized to fit on a kitchen counter top, table, or other home surface. Specifically, as shown in FIG. 1A, base 110 can have a first dimension D1 and a second dimension D2 that define a small rectangular area in which the entirety of system 100 can be contained. Where kitchen countertops are commonly approximately 25 inches deep, for example, first dimension D1 can be approximately 24 inches and second dimension D2 can be approximately 18 inches. Furthermore, base 110 can be constructed from relatively lightweight materials to help ensure that the weight of system 100 does not exceed the loading capacity of the table or countertop. In this regard, base 110 can be made out of plastic, aluminum, a combination of both, or any other material known to those having skill in the art that is capable of enclosing the internal components of system 100 and supporting the weight of the brewing kettles positioned thereon (e.g., boil kettle 130, fermentation chamber 140, mash tun 150).

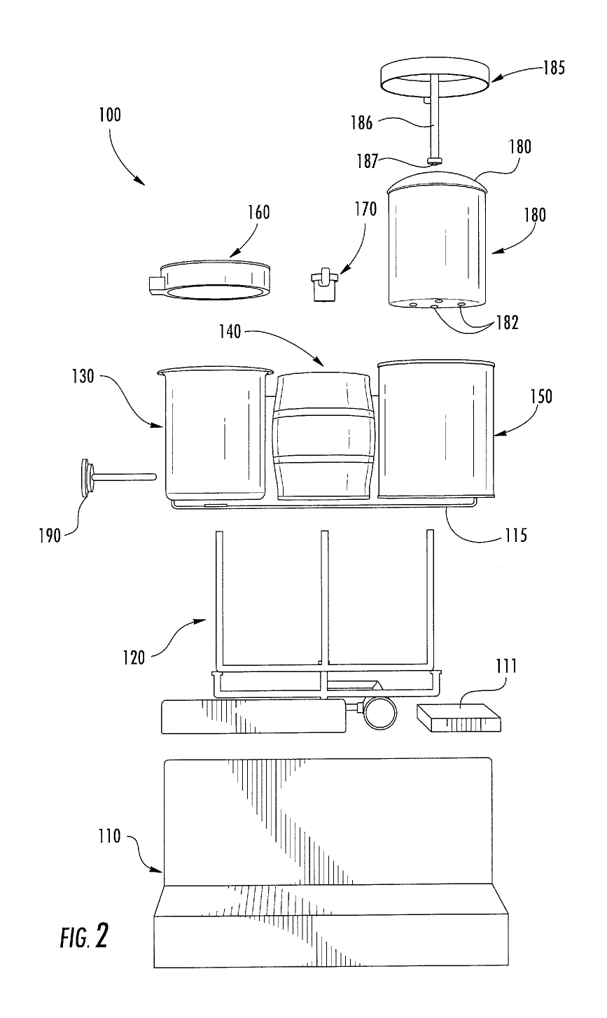

As shown in FIG. 3, pumping system 120 can comprise a pump 121 that can be connected to a plurality of controllable inlets and outlets via a system of tubing, fittings, and valves as known to those having skill in the art. Specifically, the pumping system 120 can include one or more of a first pump inlet 122a in communication with water tank 115, a second pump inlet 122b in communication with boil kettle 130, and a third pump inlet 122c in communication with mash tun 150. Pumping system 120 can further include one or more of a first pump outlet 123b in communication with boil kettle 130, a second pump outlet 123c in communication with mash tun 150, and a third pump outlet 123d in communication with fermentation chamber 140. Although FIG. 3 provides one possible configuration for connecting pumping system 120 to one or more of water tank 115, boil kettle 130, mash tun 150, or fermentation chamber 140, those having skill in the art should recognize that the particular layout of tubing, fittings, valves, and other plumbing components of pumping system 120 can be provided in any of a variety of arrangements. Furthermore, additional inlets and/or outlets can also be provided to allow introduction of fluid from other sources (e.g., supplementary water source such as a kitchen sink) or outlet of fluid from the system, such as a drain port that can be positioned at or near a lowest point of pumping system 120 and that can be used to drain the system. Each pump inlet and outlet can be configured to selectively provide fluid to or from the connected component through pumping system 120. For example, each pump inlet and outlet can comprise a valve (e.g. a solenoid valve) that is selectively controllable, either manually or via control system 111, to open or close as desired to allow fluid flow to or from the components of system 100.

In this configuration, the multiple inlets and outlets of pumping system 120 can be selectively controlled to transfer fluid into, out of, and among the fluid-carrying vessels of system 100. This selective flow-routing can enable both fundamental processes in brewing such as, but not limited to, the introduction of hot water to grain and the establishment of a grain bed, as well as additional processes such as, but not limited to, the continuous flow of wort through the grain situated in the mash tun (e.g., for sparging), the introduction of additional water after a boil, a second running of wort through a grain bed, or additional hopping of a wort.

System 100 generally described above can be used to streamline and at least partially automate a whole-grain brewing process. First, when a brewer is ready to initiate a brewing process, boil kettle 130, fermentation chamber 140, and mash tun 150 can be attached or otherwise positioned on base 110. Water and a cleaning agent can be added to boil kettle 130 and water to water tank 115 to initiates a cleaning routine. This cleaning can be assisted by pumping system 120, which can move the cleaning agent though pumping system 120 to ensure that the system has not built up any bacteria or other undesirable detritus since the last brew. The cleaning liquid can then be rinsed from system 100 with water from water tank 115. Alternatively, the cleaning routine could contain a step where water is heated to a boil (i.e., in boil kettle 130) and moved through the system further sterilizing the system components. Operation of this entire process can be at least partially automated by using control system 111 to selectively control the flow to and from each brewing vessel of system 100 within pumping system 120 (i.e., by selectively opening and closing the inlets and outlets of pumping system 120 and operating pump 121).

With system 100 cleaned and sanitized, water can be transferred from water tank 115 to boil kettle 130. As described above, for example, water tank 115 can be provided on base 110 in communication with pumping system 120. In this configuration, only first pump inlet 122a and first pump outlet 123b can be opened and pump 121 can be operated to transfer water into boil kettle 130. Alternatively, rather than providing a dedicated water tank integrated with system 100, water can be supplied to boil kettle 130 from an external water source such as a kitchen sink.

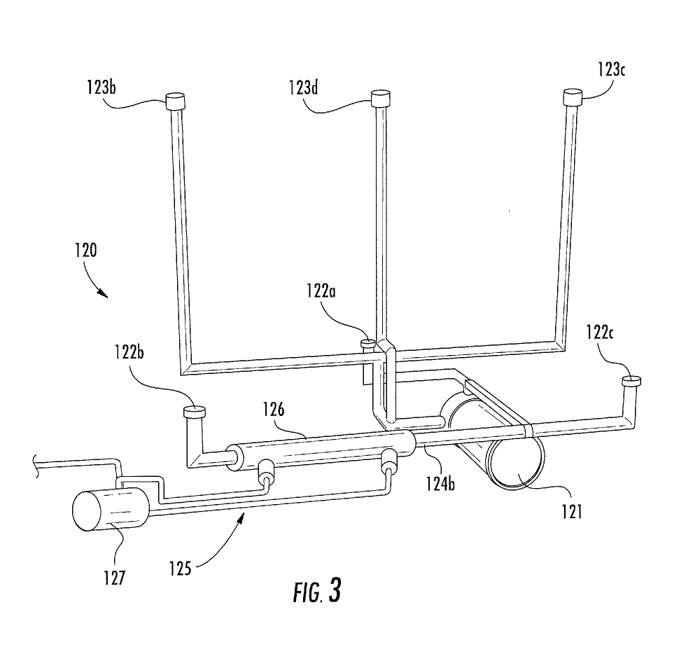

FIG. 4 illustrates a simplified depiction of components that can be associated with boil kettle 130. In one particular embodiment boil kettle 130 can be constructed of any of a variety of materials known in the art for carrying a volume of fluid (e.g., water) and heating and maintaining the fluid to temperatures up to 100° C. (212° F.) or greater. For example, brewing pots composed of stainless steel, aluminum, copper, ceramics, or combinations thereof are considered suitable for use as boil kettle 130. In particular, for instance, boil kettle 130 can comprise a stainless steel pot that is approximately 7 inches in diameter and 8.5 inches in height and is configured to hold at least approximately 1.25 gallons comfortably, thereby providing enough volume for 1-gallon batches of final product after evaporation during the boil. When filling boil kettle 130 (e.g., from water tank 115 as discussed above), the volume added can be determined using one or more first liquid level sensor 133 provided in communication with boil kettle 130. For example, first liquid level sensor 133 can comprise a float switch, an optical level sensor, or any other mechanism for helping to measure whether a desired fluid level (and thus fluid volume) is being maintained within boil kettle 130.

When the desired water volume is achieved, the water in boil kettle 130 can be heated. A first heating element 190 can be associated with boil kettle 130 and can be configured for heating the fluid contained in boil kettle 130 and maintaining the temperature of that fluid at a desired level. As shown in FIG. 4, first heating element 190 can comprise an immersion heater coupled to a sidewall of boil kettle 130. For example, where system 100 is sized to produce one-gallon batches of beer, first heating element 190 can be a 1400 W heating element. The amount of heating provided by first heating element 190 can be regulated by cycling first heating element 190 on and off, or current provided to first heating element 190 can be controlled such that only limited power is provided to first heating element 190. In one particular configuration, for example, a 6 A rectifier diode can be connected between first heating element 190 and its power source, and if reduced heating is desired (i.e., less than the full power of the heating element), the rectifier diode can be switched into the circuit to reduce power consumption (e.g., to about 360 W). Alternatively, first heating element 190 can be an electric surface heating element (i.e., a “hot plate”) or a gas burner positioned on base 110 beneath boil kettle 130 or any other form of heating element known to those having skill in the art and operable to achieve the desired heating.

For an initial brewing step, the water in boil kettle 130 can be heated to a desired “strike” water temperature to be added to grains in a next brewing step. A first temperature sensor 132 can further be associated with boil kettle 130. For example, temperature sensor can be a thermocouple probe as shown in FIG. 4, or it can be a thermistor or other temperature sensor configured for consistently measuring the temperature of fluid contained in boil kettle 130. In this configuration, where a specific water temperature is desired, the power provided to first heating element 190 can be regulated (e.g., by cycling power to first heating element 190 on and off) in response to feedback from first temperature sensor 132 to control the amount of heating provided.

With this array of sensors, the outside of boil kettle 130 can include electrical terminals configured to connect one or more of first heating element 190, first temperature sensor 132, and/or liquid level sensor 133 to control system 111. In addition, the operation of both second pump inlet 122b and first pump outlet 123b can likewise be controlled electrically by control system 111. In this configuration, the filling, heating, and evacuation of fluid in boil kettle 130 can be fully or partially automated.

When the water in boil kettle 130 is heated to the desired temperature, it can be ready to be transferred to mash tun 150 for a “mashing” step. For this transfer, boil kettle 130 can include a boil kettle drain port 131 positioned at or near its bottom that can be connected to second pump inlet 122b as discussed above. In particular, there can be a detachable plumbing fitting in the bottom of boil kettle 130 that connects boil kettle 130 to pumping system 120 through second pump inlet 122b. Similarly, boil kettle 130 can be further connected to pumping system 120 through first pump outlet 123b, either through a further detachable plumbing fitting or via a spout positioned over the top of boil kettle 130. With detachable fittings, boil kettle 130 can be removed after a brew session and cleaned in a sink or dishwasher.

In addition, a first screen or other filter 136 (e.g., a stainless steel screen) can be positioned at the bottom of boil kettle 130 above boil kettle drain port 131 to filter any particulate matter contained in the fluid passing from boil kettle 130. For example, first screen 136 can be sized so cover substantially the entire bottom of boil kettle 130. For instance, first screen 136 can be a substantially circular disk having a diameter substantially equal to a diameter of boil kettle 130 such that it extends to the outer edge of boil kettle 130. Those having skill in the art will recognize, however, that other configurations for first screen 136 (e.g., bowl shape or snorkel shape) can be used to provide the desired filtering.

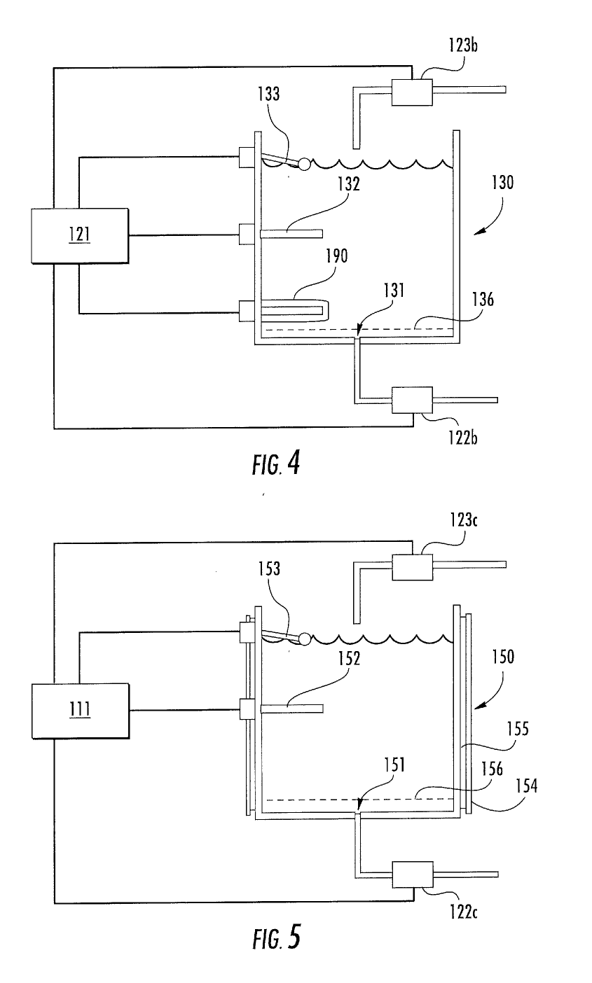

Referring to FIG. 5, a simplified depiction of components that can be associated with mash tun 150 is provided. Similarly to boil kettle 130, mash tun 150 can be constructed of any of a variety of heat-safe materials (e.g., stainless steel, aluminum, copper, ceramics, or combinations thereof). Like boil kettle 130, mash tun 150 can comprise a stainless steel pot that is approximately 7 inches in diameter and 8.5 inches in height and is configured to hold at least approximately 1.25 gallons of liquid therein. Before hot water is transferred from boil kettle 130 to mash tun 150, the brewer can prepare and measure brewing grains (e.g., malted barley or other grain adjuncts discussed above) into mash tun 150 according to a desired recipe for the beer to be produced. As noted above, where system 100 is configured for smaller beer batches than conventional brewing systems (e.g., about 1 gallon), the amount of grains necessary can be correspondingly smaller, even for many ingredient-heavy recipes, thereby lessening the ingredient cost. Then, the hot water can be transferred to mash tun 150 (e.g., using pumping system 120 as described above), and the grain and water can be allowed to “mash” together for a predetermined time period.

In this regard, a mash tun lid 185 can be positioned atop mash tun 150 to provide insulation for mash tun 150 as well as a means of reducing loss of liquid volume through evaporation. Mash tun lid 185 can be provided in communication with second pump outlet 123c. In such a configuration, a stem 186 can extend from mash tun lid 185 down into mash tun 150, thereby allowing liquid to be input into the center of mash tun 150. At the end of stem 186 can be a reducing fitting 187, which can increase the velocity of the liquid leaving stem 186 to provide jet agitation if desired. This allows for an even distribution of hot liquid throughout the grain, which can be beneficial for making good “wort” (i.e., liquid extracted from the mashing process that contains the sugars that will be fermented by the brewing yeast to produce alcohol). Alternatively, a valve (e.g., a solenoid) on mash tun lid 185 can allow for liquid from second pump outlet 123c to bypass the jet agitation system, allowing for liquid to be added slowly and gently on top of mash tun 150, as can be desirable during a sparging process as described below.

Mash tun 150 can be coupled to a second temperature sensor 152 (e.g., a thermocouple, thermistor) and a second liquid level sensor 153 (e.g., a float switch, an optical level sensor) for measuring the liquid temperature and level, respectively, within mash tun 150 to help ensure that proper conditions for the mash are maintained during that time. Each of second temperature sensor 152 and second liquid level sensor 153 can be electrically coupled to control system 111, which can be further connected to a computer to monitor the temperature and volume of the slurry formed in mash tun 150.

To help maintain good temperature control in mash tun 150, mash tun 150 can be well insulated along the surface of the kettle. For example, an insulation layer 154 can be positioned to substantially surround mash tun 150 to help prevent heat loss. In simple configurations, for example, insulation layer 154 can comprise a segment of Polyvinyl chloride (PVC) pipe sized to surround mash tun 150 (e.g., where mash tun 150 is a 7-inch wide pot as discussed above, insulation layer 154 can be a segment of PVC pipe having a diameter of about 8 inches). If the temperature falls below a desired range, additional hot water may be added to mash tun 150 (i.e., from boil kettle 130). Alternatively or in addition, a second heating element 155 can be associated with mash tun 150. For example, second heating element 155 can comprise a heating pad adhered to the outside of mash tun 150. In the configuration shown in FIG. 5, for example, second heating element 155 can be positioned under insulation layer 154, and a filler material (e.g., expanding foam) can be used to fill any remaining gaps between insulation layer 154 and mash tun 150. In this regard, second heating element 155 can be a relatively low-wattage device in comparison to first heating element 190 used in boil kettle 130. Even where mash tun 150 is well-insulated, second heating element 155 can be useful for adjusting and maintaining the temperature of the fluid contained in mash tun (e.g., wort).

Once the grains within mash tun 150 have been “mashed” for a sufficient period of time, the wort can begin to be transferred back to boil kettle 130 for a next brewing step. In this regard, mash tun 150 can include a mash tun drain port 151 positioned at or near its bottom that can be connected to third pump inlet 122c as discussed above. Again, detachable plumbing fittings can be used to connect mash tun 150 to pumping system 120 through third pump inlet 122c and second pump outlet 123c. With detachable fittings, boil kettle 130 can be removed after a brew session and cleaned in a sink or dishwasher. A second screen 156 (e.g., a stainless steel screen) can be positioned at the bottom of mash tun 150 above mash tun drain port 151 and can be sized so cover substantially the entire bottom of mash tun 150. For instance, second screen 156 can be a substantially circular disk that extends to the outer edge of mash tun 150, or it can have another shape selected to provide the desired filtering. In addition, second screen 156 can function to help establish a grain bed following a mashing procedure.

Alternatively, as shown in FIG. 2, a removable mash tun basket 180 can be configured to be inserted into mash tun 150 for holding brewing grains and helping to keep any solid matter from passing into pumping system 120. For example, mash tun basket 180 can be a stainless steel basket having solid or mesh sides and a perforated or mesh bottom. Mash tun basket 180 can have a handle 181 for easy removal, and it can have a plurality of feet 182 that can provide separation of the bottom of mash tun basket 181 from the bottom of mash tun 150. Such separation from the bottom of mash tun 150 can be desirable in setting up a grain bed following the mash (e.g., during a sparging process). The use of mash tun basket 181 can further help to provide for easy clean-up of used grain after a brew session.

In either configuration, liquid can be recirculated through mash tun 150 (i.e., out second drain port 151 through third pump inlet 122c and back into mash tun 150 through second pump outlet 123c), which can set up a grain bed. Meanwhile, additional water can be transferred into boil kettle 130 from water tank 115 and heated to a desired “sparge” temperature. At this point, a cyclical process can be set up for transferring liquid from boil kettle 130 into mash tun 150 and liquid from mash tun 150 into boil kettle 130. This process is referred to as a sparge which draws out further sugars from the grain and uses the grain bed as a filter to clarify the wort. Although not necessary for producing beer, a sparge can be desirable to rinse sugars out of the mash and into boil kettle 130. Further, a careful sparge can clarify the wort using the grain bed as a filter system, reducing the amount of particulate content in the final beer. To avoid over-agitating the grain while the grain bed is formed, the cycling of fluid through mash tun 150 can be performed at a reduced flow rate, for example by controlling the flow rate through pump 121. This can be done simply through control system 111 by reducing the voltage applied to pump 121.

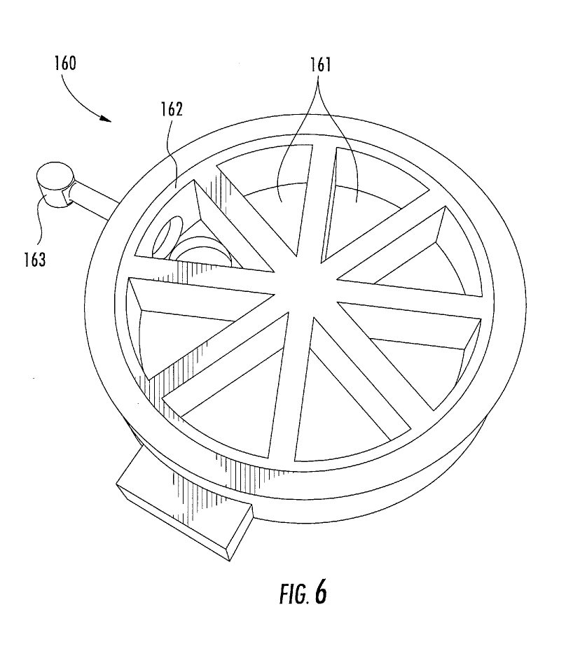

After sparging for a desired number of recirculation cycles, the wort can be transferred entirely back to boil kettle 130. An additions dispenser 160 can further be provided in communication with boil kettle 130 and can be located above boil kettle 130 as shown in FIGS. 1A and 1B. For example, additions dispenser 160 can be positioned at least partially above boil kettle 130 but sufficiently to one side so as to not completely cover the top of boil kettle 130. In this way, steam generated during a boil process can be allowed to escape, which can help to prevent the development of off flavors in a finished beer. Additions dispenser 160 can be positioned in communication with pumping system 120 downstream of first pump outlet 123b such that any fluid pumped through pumping system 120 into boil kettle 130 must first pass through additions dispenser 160. Alternatively, additions dispenser can be independent from pumping system 120. In any configuration, as shown in FIG. 6, additions dispenser 160 can comprise one or more compartment 161 that can be configured to hold solid or liquid additions (e.g., measured hop additions, other aromatic and flavor additions). For example, compartments 161 can be arranged radially around a central hub, and each compartment 161 can be selectively accessed in turn through the rotation of additions dispenser 160 until a desired compartment 161 is in communication with boil kettle 130 (e.g., via an access port 162 in the bottom of additions dispenser 161). In addition, where additions dispenser 160 is connected to pumping system, a plumbing connection 163 can be provided in the side or top of additions dispenser 160 such that the additions can be washed into boil kettle 130.

Again, first heating element 190 can be activated (e.g., by a computer in communication with control system 111), and the temperature in boil kettle 130 can be monitored using first temperature sensor 132. At specified time intervals prescribed by the beer recipe for the given brewing process, additions dispenser 160 can be activated (e.g., by rotating another of compartments 161 into communication with access port 162), and water from water tank 115 can be pumped through additions dispenser 160 (e.g., by opening the appropriate inlets and outlets and turning on pump 121), flushing the additions into the boil. Further careful monitoring of the liquid temperature and level in boil kettle 130 can prevent a common “boil over” event, which can save the brewer a mess to clean up. By cycling first heating element 190 on and off or electronically switching the current, an even, gentle boil can be maintained.

Once the wort has been boiled for the prescribed time period, and all additions have been added from additions dispenser 160, the hot wort can be cooled. For example, a wort chiller 125 can be connected in communication with boil kettle 130 and pumping system 120 to cool the boiled wort down to yeast pitching temperatures. As shown in FIG. 2, for example, wort chiller 125 can include a combination of thermoelectric plates (e.g., Peltier plates), channeled metal blocks, and heat sinks. In this configuration, the ‘cold side’ of the Peltier plate can chill the metal blocks, and the ‘hot side’ of the Peltier plate can be in contact with the heat sink. The temperature of liquid flowing through channels in the metal blocks can thus be reduced. For best results, materials used in this system can be selected to have good thermal conductivity, such as copper or aluminum.

Alternatively, as show in FIG. 3, the wort chiller 125 can comprise a counter flow chilling system. For example, a cooling pipe 126 having an inner diameter that is larger than an outer diameter of fluid piping used in pumping system 120 can be placed concentrically with the fluid piping 124b in communication with second pump inlet 122b over a desired length (e.g., about 16 inches). A secondary pump 127 can be operable to flow ice water (e.g., stored in an additional vessel, such as an additional water tank 115 as shown in FIG. 1B) through cooling pipe 126 over fluid piping 124b as pump 121 pushes the boiled wort through fluid piping 124b. Those having skill in the art should recognize that although cooling pipe 126 is shown in FIG. 3 as being arranged over a portion of fluid piping 124b in communication with second pump inlet 122b (e.g., within base 110 substantially beneath boil kettle 130), any of a variety of piping configurations can be used. For example, cooling pipe 126 can alternatively be arranged over a portion of fluid piping in communication with first pump outlet 123b. In this alternative configuration, the heated wort can be cooled by recirculating the wort out of second pump inlet 122b and back into boil kettle 130 through first pump outlet 123b. In any configuration, it can be desirable for wort chiller 125 to be able to reduce the temperature of the hot fluid from boil kettle 130 (e.g., boiled wort) down to room temperature in a reasonable amount of time.

In any configuration, the fluid can be passed in one or more cycles (e.g., by recirculating the hot wort from boil kettle 130 through pumping system 120 and back into boil kettle 130) while wort chiller 125 is activated. Because of the small size of system 100 compared to conventional home brewing systems, this temperature reduction can be accomplished relatively quickly (e.g., in about 10 minutes in some configurations) even where wort chiller 125 is comparatively smaller than conventional cooling systems. In addition, the chilling process that takes the temperature of the hot fluid in boil kettle 130 from boiling to the point where it is safe to introduce yeast is traditionally a messy and clumsy process, and one where off flavors may be introduced in the beer. For example, in most home brew systems, this cooling is done either by placing the boil kettle in an ice bath or by using and immersion chiller or a counter flow chiller. In contrast, by directly chilling the wort in pumping system 120, the present systems and methods substantially eliminate the chance of spillage during transfer to an ice bath, the chance of contamination during the introduction of an immersion chiller, and the bulky complexity of a secondary cooling line and pumping system needed for a conventional counter flow chiller. Further, as the boil liquid will be very hot during its first pass through wort chiller 125, it is very unlikely that bacteria in the system will survive during this process.

Once the temperature of the wort has been reduced to a suitable temperature for “pitching” yeast (e.g., as measured by first temperature sensor 132), the liquid can be transferred from boil kettle 130 to fermentation chamber 140. In this regard, for example, second pump inlet 122b and third pump outlet 123d can be opened, and pump 121 can be operated to pump the cooled wort out of boil kettle 130, through boil kettle drain port 131 and into fermentation chamber 140. Fermentation chamber 140 can be attached or otherwise positioned on base 110 as shown in FIGS. 1A and 1B and discussed above, or it can be separate from system 100 (i.e., third pump outlet 123d can provide a spout that extends from system 100). Fermentation chamber 140 can be a stainless steel, plastic, or glass container with an opening in its top that can be attached or otherwise positioned upon base 110. In one particular configuration, for example, fermentation chamber 140 can be a one-gallon glass jug. This can be a considered a “primary” fermentation container. In some advanced brewing recipes, a “secondary” fermentation container is called for at the end of fermentation. In such a situation, a spout on top of fermentation chamber 140 can be provided to allow for easy pouring from the “primary” to “secondary” fermentation container.

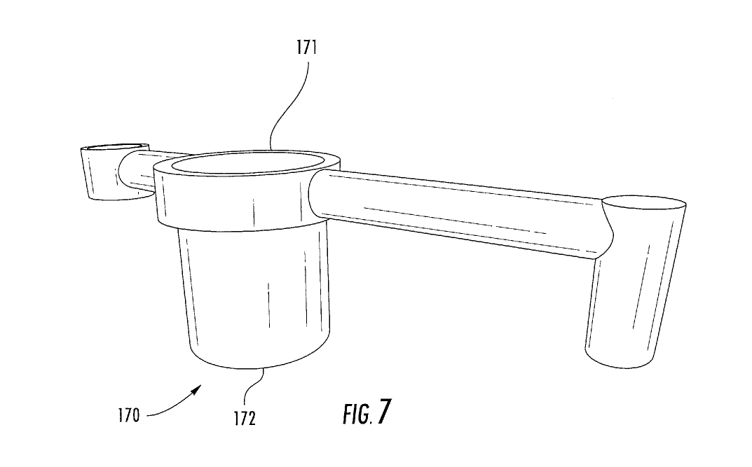

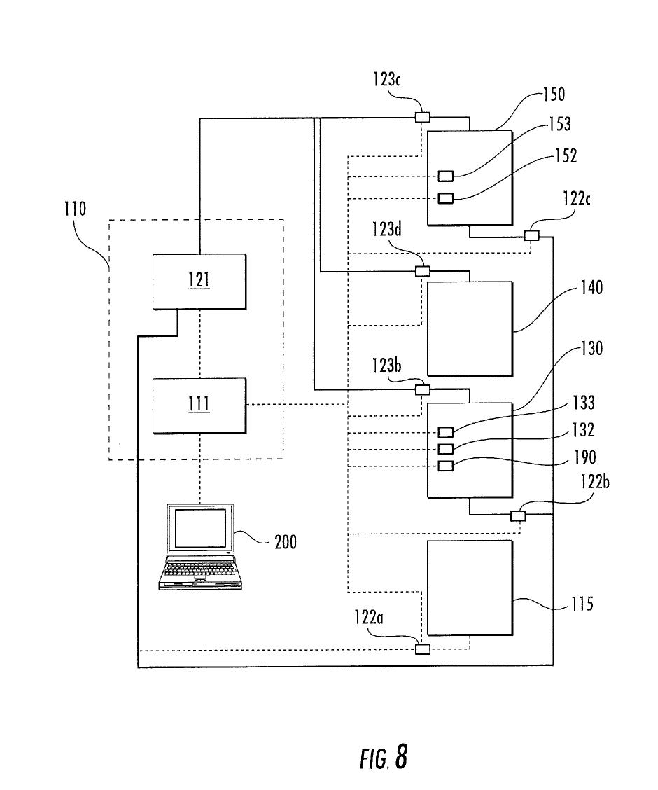

During or after the transfer of the cooled wort to fermentation chamber 140, activated yeast can be added according to the recipe being produced. To assist this process, a yeast mixer 170 can be provided in-line between pumping system 120 and fermentation chamber 140 to automate the addition of yeast to the cooled wort. As shown in FIG. 7, for example, yeast mixer 170 can comprise a plumbing fitting 171 that can be coupled to a detachable yeast container 172, much like an in-line filter housing. Yeast mixer 170 can be connected in communication with fermentation chamber 140 and third pump outlet 123d. Detachable yeast container 172 can be a detachable clear plastic container for holding yeast, which can be screwed or otherwise attached to plumbing fitting 171. In this configuration, liquid pumped through yeast mixer 170 must pump through detachable yeast container 172. One advantage of this arrangement can be that a small amount of wort can be left in detachable yeast container 172 at the end of a brew process. This liquid can then be tested by the brewer for specific gravity, which is often a desirable measurement in determining the total alcohol content of the final beer. Another advantage of this configuration of yeast mixer 170 can be that the wort-yeast mixture can be well-aerated during the transfer into the fermentation chamber, as the liquid would drop a distance from the outlet of yeast mixer 170 and splash on the bottom of fermentation chamber 140 (e.g., about a foot drop).

Once fermentation chamber 140 is filled and the yeast added (e.g., through yeast mixer 170), the brewing process is substantially complete. The brewer can remove fermentation chamber 140 from system 100 and seal it from possible contaminates. The brewer can further remove mash tun basket 180 (if present) and run a cleaning cycle through pumping system 120. In addition, the brewer can remove boil kettle 130, mash tun 150, and any other detachable components (e.g., yeast container 172) and wash them by hand or in an automatic dishwasher. System 100 can then be ready for the next brewing process.

As indicated in the description above, any or all of the operational control of system 100 can be performed by control system 111. Control system 111 can be configured to allow for either or both of manual control (e.g., via an array of switches, displays, etc.) and computer control (e.g., via a connected computer 200). For example, control system 111 can be operable to turn pump 121 on and off, open and close any valves in pumping system 120 (e.g., valves associated with first pump inlet 122a, second pump inlet 122b, third pump inlet 122c, first pump outlet 123b, second pump outlet 123c, and third pump outlet 123d), turn first and second heating elements 190 and 155 on and off, monitor first and second temperature sensors 132 and 152 and first and second liquid level sensors 133 and 153, and control the operation of additions dispenser 160. For manual control, lights can be provided on an exterior surface of base 110 to indicate the status of the liquid level sensors, valve positions, and pump status. Displays can indicate temperature readings from the temperature sensors. All switching may be done manually from a front panel of base 110.

For computer control, temperature and float switch values can be read in from either an external of internal microprocessor (e.g., an micro-controller or a data acquisition (DAQ) board). Also, computer signals in parallel with manual controls can actuate digital or physical relays to control all of the aforementioned process steps. Control system 111 can further be configured to record a brew process, read, write, and automate implementation of brewing recipes, log brew notes and pictures, and provide graphical visualization of brew processes.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A system for brewing beer comprising:
a base;
a boil kettle positioned on the base;
a first heating element in communication with the boil kettle and configured to selectively heat fluid contained in the boil kettle;
a mash tun positioned on the base, the mash tun configured to receive one or more solid or fluid materials therein;
a pumping system positioned at least partially within the base and connected to the boil kettle and the mash tun, the pumping system being operable to selectively pass fluid into, out of, and among the boil kettle and the mash tun; and
a control system positioned at least partially within the base and configured to selectively control the first heating element and the pumping system.

2. The system of claim 1, wherein the base is sized to occupy an area less than that of a kitchen countertop.

3. The system of claim 1, comprising one or more first temperature sensors or first fluid level sensors in communication with the boil kettle and connected to the control system.

4. The system of claim 1, comprising an additions dispenser in communication with the boil kettle, the additions dispenser comprising one or more compartment configured for receiving one or more additive ingredients, the additions dispenser being in communication with the control system and controllable by the control system to selectively transfer the one or more additive ingredients from the additions dispenser to the boil kettle.

5. The system of claim 1, comprising a second heating element in communication with the mash tun, the second heating element being in communication with the control system and controllable by the control system to selectively heat fluid contained in the mash tun.

6. The system of claim 1, comprising one or more second temperature sensors or second fluid level sensors in communication with the mash tun and connected to the control system.

7. The system of claim 1, wherein the pumping system comprises:
a pump;
a first pump inlet in communication between a water source and the pump;
a first pump outlet in communication between the pump and the boil kettle;
a second pump inlet in communication between the boil kettle and the pump;
a second pump outlet in communication between the pump and the mash tun;
a third pump inlet in communication between the mash tun and the pump; and
a third pump outlet in communication with the pump;
wherein each of the first pump inlet, the first pump outlet, the second pump inlet, the second pump outlet, the third pump inlet, and the third pump outlet are in communication with the control system and are controllable by the control system to selectively open or close.

8. The system of claim 7, wherein the water source comprises a water tank positioned on the base, the pumping system being operable to selectively pass fluid out of the water tank.

9. The system of claim 7, comprising a wort chiller in communication with the pumping system between the second pump inlet and the pump, the wort chiller being in communication with the control system and controllable by the control system to selectively cool fluid passed between the second pump inlet and the pump.

10. The system of claim 1, comprising a fermentation chamber connected to the pumping system, the pumping system being operable to selectively pass fluid into the fermentation chamber.

11. The system of claim 10, wherein the fermentation chamber is positioned on the base.

12. The system of claim 10, comprising a yeast mixer connected in communication between the pumping system and the fermentation chamber, the yeast mixer being configured to receive yeast therein and mix the yeast with liquid passed to the fermentation chamber from the pumping system.

13. A system for brewing beer comprising:
a base;
a water tank positioned on the base
a boil kettle positioned on the base;
a first heating element in communication with the boil kettle and configured to selectively heat fluid contained in the boil kettle;
a mash tun positioned on the base, the mash tun configured to receive one or more solid or fluid materials therein;
a fermentation chamber positioned on the base;
a pumping system positioned at least partially within the base and connected to the water tank, the boil kettle, the mash tun, and the fermentation chamber, the pumping system comprising a pump operable to selectively pass fluid into, out of, and among the water tank, the boil kettle, the mash tun, and the fermentation chamber;
a wort chiller in communication with the pumping system between the boil kettle and the pump; and
a control system positioned at least partially within the base and configured to selectively control the first heating element, the pumping system, and the wort chiller.

14. The system of claim 13, wherein the base is sized to occupy an area less than that of a kitchen countertop.

15. The system of claim 13, wherein the pumping system comprises:
a pump;
a first pump inlet in communication between the water tank and the pump;
a first pump outlet in communication between the pump and the boil kettle;
a second pump inlet in communication between the boil kettle and the pump;
a second pump outlet in communication between the pump and the mash tun;
a third pump inlet in communication between the mash tun and the pump; and
a third pump outlet in communication with the pump;
wherein each of the first pump inlet, the first pump outlet, the second pump inlet, the second pump outlet, the third pump inlet, and the third pump outlet are in communication with the control system and are controllable by the control system to selectively open or close.

16. The system of claim 13, comprising an additions dispenser in communication with the boil kettle, the additions dispenser comprising one or more compartment configured for receiving one or more additive ingredients, the additions dispenser being in communication with the control system and controllable by the control system to selectively transfer the one or more additive ingredients from the additions dispenser to the boil kettle.

17. A method for brewing beer comprising:
adding brewing grains to a mash tun positioned on a base;
transferring water to a boil kettle positioned on the base;
using a first heating element in communication with the boil kettle, heating the water in the boil kettle to a desired temperature;
using a pumping system positioned at least partially within the base, pumping the water from the boil kettle onto the brewing grains in the mash tun to form a wort;
using the pumping system, pumping the wort from the mast tun to the boil kettle;
using the first heating element, heating the wort to form a heated wort;
using a wort chiller in communication with the pumping system, cooling the heated wort to form a cooled wort;
adding yeast to the cooled wort; and
using the pumping system, transferring the cooled wort from the boil kettle to a fermentation chamber;
wherein the steps of heating the water in the boil kettle, pumping the water from the boil kettle, pumping the wort from the mast tun, heating the wort, cooling the heated wort, and transferring the cooled wort from the boil kettle are selectively controlled by a control system positioned at least partially within the base.

18. The method of claim 17, wherein the fermentation chamber is positioned on the base.

19. The method of claim 17, wherein adding yeast to the cooled wort comprises passing the cooled wort through a yeast mixer connected in communication between the pumping system and the fermentation chamber.

20. The method of claim 17, further comprising, before or during the step of heating the wort, selectively transferring one or more additive ingredients from an additions dispenser to the boil kettle, wherein selectively transferring the one or more additive ingredients from the additions dispenser is controlled by the control system.
